(19) United States
(12) Patent Application Publication
(10) Pub. No.: US 2006/0228588 A1
(43) Pub. Date: Oct. 12, 2006

(54) Magnetic recording medium

(75) Inventors: Hiroyuki Suzuki, Kanagawa (JP); Hidekazu Kashiwase, Kanagawa (JP); Tatsuya Hinoue, Kanagawa (JP); Tomoo Yamamoto, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/400,736

(22) Filed: Apr. 6, 2006

(30) Foreign Application Priority Data
Apr. 8, 2005 (JP) 2005-111774

(51) Int. Cl. G11B 5/66

(52) U.S. Cl. 428/829; 428/828.1; 428/831

(57) ABSTRACT

A magnetic recording material is provided which has high medium S/N, and provides excellent overwriting characteristic, excellent thermal fluctuation and sufficient stability against thermal fluctuation. In one embodiment, a first underlayer comprising one of alloys of a Ti—Co alloy, a Ti—Co—Ni alloy, and an Ni—Ta alloy, a second underlayer comprising a W—Co alloy or Ta, and a third underlayer of a body-centered cubic structure comprising a Cr—Ti—B alloy or a Cr—Ti alloy are disposed over a substrate. A first magnetic layer comprising a Co—Cr—B alloy or a Co—Cr—Ta alloy, a second magnetic layer comprising a Co—Cr—Pt—B—Ta alloy, a third magnetic layer comprising a Co—Cr—Pt—B alloy, and a protective film are disposed further thereover. An intermediate region (Th) is disposed between the second magnetic layer and the third magnetic layer, the intermediate region having a higher oxygen concentration than those of the magnetic layers.

### CROSS-REFERENCES TO RELATED APPLICATIONS

This application claims priority from Japanese Patent Application No. JP2005-11 1774, filed Apr. 8, 2005, the entire disclosure of which is incorporated herein by reference.

### BACKGROUND OF THE INVENTION

The present invention relates to magnetic recording media capable of recording a great amount of data and, more particularly, to a magnetic recording medium suitable for magnetic recording with high-density.

A demand for magnetic disk drives with larger capacity has been increased more and more. In order to meet the demand, it has been required to develop magnetic heads with high-sensitivity and magnetic recording media with high-S/N. To improve the S/N of a medium, it is necessary to improve the read output for data that has been recorded at high-density. Generally, a magnetic recording medium comprises a first underlayer referred to as a seed layer formed on a substrate, a second underlayer of a body centered cubic structure comprising an alloy containing chromium as a main ingredient, a magnetic film, and a protective film containing carbon as a main ingredient. The magnetic film usually uses an alloy having a hexagonal close-packed structure containing cobalt as a main ingredient. To improve the read output, it is effective to orient crystals of the magnetic film such that (11.0) face or (10.0) face is substantially parallel with the plane of the substrate and direct the c-axis of the hexagonal closed-packed structure as an axis of easy magnetization to the inside of the film plane. The crystallographic orientation of the magnetic film can be controlled by the seed layer.

There is a technique of simplifying the complicated and long process or mitigating the installation cost, as well as providing a medium with high output and low noises without increasing the distance from the top end of the magnetic pole of a head to the lower magnetic layer of a magnetic recording medium. Patent Document 1 (JP No. 3434845 (U.S. Pat. No. 5,587,235)) discloses as the technique a magnetic recording medium comprising plural magnetic film layers formed by way of a non-magnetic underlayer over a substrate. In this medium, an intermediate layer of a higher oxygen concentration compared with each of the magnetic layers is formed between a pair of layers among the plural magnetic layers, the intermediate region has island portions or separated portions, and the plural magnetic layers are partially in contact with each other where crystals are grown.

In the magnetic recording medium described in the Patent Document 1, in a case where an intermediate layer of a higher oxygen concentration compared with that of the plural magnetic layers is present between each of the plural magnetic layers, it is not always possible to improve bit errors and reduce thermal fluctuation. To improve high-density magnetic recording it is necessary to improve the bit error rate of read signals, while, to maintain data for a long time it is necessary to suppress degradation of the read signals due to thermal fluctuation.

### BRIEF SUMMARY OF THE INVENTION

A feature of the present invention is to improve a bit error rate and reduce thermal fluctuation in a magnetic recording medium in which a plurality of magnetic layers are formed by way of a non-magnetic underlayer film over a substrate.

In accordance with an aspect of the present invention, a magnetic recording medium comprises: a substrate; an underlayer film stacked on the substrate; a first magnetic layer of a Co-based alloy containing Cr stacked on the underlayer film; a second magnetic layer which is a Co-based alloy layer containing Cr, Pt, and B and stacked on the first magnetic layer and has higher Cr concentration and larger film thickness than those of the first magnetic layer; a third magnetic layer which is a Co-based alloy layer containing Cr, Pt, and B and stacked on the second magnetic layer and has lower Cr concentration than that of the second magnetic layer; an intermediate region formed between the second magnetic layer and the third magnetic layer and having a higher oxygen concentration than that of the magnetic layer; and a protective film stacked on the third magnetic layer. Since the intermediate region with high oxygen concentration is provided between the second magnetic layer and the third magnetic layer, the crystal grains of the third magnetic layer is miniaturized to improve the S/N, which improves the bit error rate.

In specific embodiments, the first magnetic layer has a film thickness of about 1 nm or more and about 1.5 nm or less. The underlayer film comprises a plurality of underlayers and an underlayer in contact with the first magnetic layer contains B. Preferably, the underlayer film has a first underlayer for ensuring sliding reliability, a second underlayer for ensuring mechanical reliability, and a third underlayer for miniaturizing crystal grains in the first magnetic layer film.

In some embodiments, the underlayer film has a first underlayer comprising any one of a TiCo alloy, a TiCoNi alloy, and a NiTa alloy, a second underlayer comprising a WCo alloy or Ta, and a third underlayer comprising a CrTiB alloy or a CrTi alloy. It is preferred that the first magnetic layer be a CoCrPt alloy layer, the second magnetic layer be a CoCrPtBTa alloy layer, and the third magnetic layer be a CoCrPtB alloy layer.

In accordance with another aspect of the invention, a magnetic recording medium comprises: a substrate; an underlayer film stacked on the substrate; a first magnetic layer of a Co-based alloy containing Cr stacked on the underlayer film; a second magnetic layer which is a Co-based alloy layer containing Cr, Pt, and B and stacked on the first magnetic layer and has higher Cr concentration and thicker film thickness than those of the first magnetic layer; a third magnetic layer which is a Co-based alloy layer containing Cr, Pt, and B and stacked on the second magnetic layer and has lower Cr concentration than that of the second magnetic layer; an intermediate region formed between the second magnetic layer and the third magnetic layer and having an ArO₂ concentration higher than that of the magnetic layer; and a protective film stacked on the third magnetic layer.

In specific embodiments, the first magnetic layer has a thickness of about 1 nm or more and about 1.5 nm or less. The underlayer film comprises a plurality of underlayers and an underlayer in contact with the first magnetic layer contains B. Preferably, the underlayer film has a first underlayer for ensuring sliding reliability, a second underlayer for ensuring mechanical reliability, and a third underlayer for miniaturizing crystal grains in the first magnetic layer film.

In some embodiments, the underlayer film has a first underlayer comprising any one of a TiCo alloy, a TiCoNi alloy, and a NiTa alloy, a second underlayer comprising a WCo alloy or Ta, and a third underlayer comprising a CrTiB alloy or a CrTi alloy. Preferably, the first magnetic layer is a CoCrPt alloy layer, the second magnetic layer is a CoCrPtBTa alloy layer, and the third magnetic layer is a CoCrPtB alloy layer.

The present invention can provide a longitudinal magnetic recording medium that has high medium S/N, and provides excellent overwriting characteristic, excellent thermal fluctuation and sufficient stability against thermal fluctuation. Further, a combination of the medium with a magnetic head with high density can attain an in-plane recording density of 95 Mbits per 1 mm².

### BRIEF DESCRIPTION OF THE DRAWINGS

FIG. 1 is cross sectional structural views of magnetic recording media according to embodiment 1 of the present invention and comparative example 1.

FIG. 2 is a diagram showing the relationship between the base pressure (vacuum) and residual gas in an sputtering apparatus.

FIG. 3 is a diagram showing the constitution of embodiment 1 and comparative example 1, as well as magnetic characteristic and electromagnetic conversion characteristics.

FIG. 4 is a diagram showing the magnetic characteristic and the electromagnetic conversion characteristic in a case of changing the thickness tM1 of the magnetic layer according to embodiment 2.

FIG. 5 is a cross sectional constitutional view of embodiment 3.

FIG. 6 is a diagram showing the magnetic characteristic and the electromagnetic conversion characteristic in embodiment 3.

FIG. 7 is a view showing magnetic characteristic and electromagnetic conversion characteristic in embodiment 4.

### DETAILED DESCRIPTION OF THE INVENTION

Specific embodiments of the present invention will be described with reference to the drawings.

### Embodiment 1

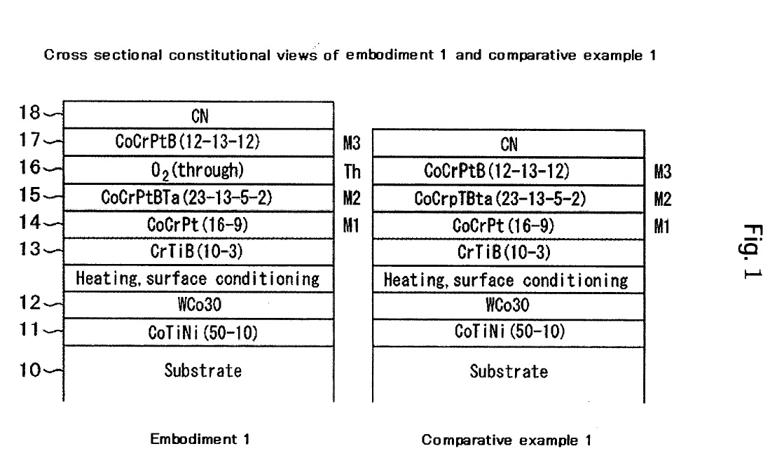

FIG. 1 shows cross sectional constitutions of embodiment 1 and comparative example 1. A magnetic recording medium of embodiment 1 includes underlayer films (11, 12, 13), a first magnetic layer 14, a second magnetic layer 15, a third magnetic layer 17, and a protective film 18, which are laminated over a substrate 10. In addition, an intermediate layer (Th) of a higher oxygen concentration than that of the magnetic layers is provided between the second magnetic layer 15 and the third magnetic layer 17. Although not illustrated, a lubrication film may also be formed on the protective film 18.

It is preferred to use, as the substrate 10, a chemically reinforced glass substrate, or a rigid substrate in which a phosphorus-containing nickel alloy is plated on an aluminum alloy. It is preferred in view of providing magnetic anisotropy to apply fine texturing on the substrate substantially in the circumferential direction of a disk. The substrate 10 may measure 84 mm in outer diameter, 25 mm in inner diameter, and 1.27 mm in thickness, for example, in terms of the shape thereof. In addition, it may have a maximum surface roughness height Rmax of 3.5 nm, and an average surface roughness Ra of 0.35 nm. Alternatively, the substrate 10 may measure 65 mm in outer diameter, 20 mm in inner diameter, and 0.35 mm thickness, and it may have a Rmax of 2.68 to 4.0 nm, and a Ra of 0.23 to 0.44 nm. There is no particular limitation on the shape thereof. The surface roughness measured in the radial direction of the disk was determined by observing an area of 5 μm square under an intermediate contact type atomic force microscope. A sufficient flying reliability was obtained by using a substrate having a maximum height Rmax of 2.68 to 4.2 nm and an average surface roughness Ra of 0.23 to 0.44 nm.

The underlayer films 11, 12, and 13 are formed between the substrate 10 and the first magnetic layer 14. This can control the crystallographic orientation of the magnetic films and miniaturize the crystal grains. In this embodiment, the first underlayer 11 comprising one of alloys of a Ti—Co alloy, a Ti—Co—Ni alloy, and an Ni—Ta alloy, the second underlayer 12 comprising a W—Co alloy or Ta, and the third underlayer 13 of a body-centered cubic structure comprising a Cr—Ti—B alloy or a Cr—Ti alloy are disposed between the substrate 10 and the first magnetic layer 14.

The first underlayer 11 can use,. e.g., a Ti-50 at %.Co alloy, a Ti-40at. % Co-10at. % Ni alloy or an Ni-38at. % Ta alloy. The thickness is preferably more than 10 nm in view of the sliding reliability and it is also preferred that the thickness be about 30 nm or less in view of production. In addition, micro crystalline or amorphous metal thin films may also be used in place of the compositions described above.

The second underlayer 12 can use a W-30at. % Co alloy or Ta. Since the mechanical reliability is deteriorated when the thickness of the second underlayer 12 is excessively large, the second underlayer 12 is preferably 5 nm or less.

The third underlayer 13 can use a Cr(10 to 15)at. % Ti(3 to 7)at. % B alloy, as well as a Cr—Ti alloy not containing boron (B), e.g., a Cr-12.5at. % Ti alloy. It is preferred to add boron (B) to the third underlayer for miniaturization of crystal grains in an electric discharge atmosphere with no intentional addition of oxygen or nitrogen. The addition concentration of boron can be selected such that the coercive force takes a desired value. In a case where boron is added in excess of 10 at. %, crystal grains are miniaturized excessively.

The first magnetic layer 14 can use those alloys not simultaneously containing platinum (Pt), tantalum (Ta), and boron (B) such as a Co—Cr alloy, a Co—Cr—B alloy, a Co—Cr—Pt alloy, and a Co—Cr—Ta. In particular, a Pt-containing alloy is preferred since its surface is relatively inert even when the alloy is formed into a thin film and a thin film with a reduced residual magnetic flux density can be formed stably.

The multiple magnetic layers have a constitution in which three layers are stacked not by way of a non-magnetic layer such as ruthenium. That is, the magnetic films are continuously sputtered with no interposition of an intermediate layer between the magnetic layers, the intermediate layer being adapted for anti-ferromagnetically coupling the magnetic layers.

In a case of using the Co—Cr—B alloy or Co—Cr—Ta alloy as the first magnetic layer 14, when a Cr—Ti alloy not containing B is used as the third underlayer 13, the magnetic in-plane orientation can be increased. On the other hand, in a case of using the Co—Cr alloy or Co—Cr—Pt alloy not containing B, as the first magnetic layer 14, since the crystal grains of the underlayer are miniaturized when the Co—Ti alloy containing B is used as the third underlayer 13, crystal grains of the magnetic layer 14 formed thereon are also miniaturized to reduce medium noises. When the thickness of the first magnetic layer 14 is about 1.0 nm or more and about 1.5 nm or less, it is possible to increase the coercivity of the medium, as well as improve the bit error rate.

The coercivity of the medium is ensured by incorporating Pt in the second and third magnetic layers 15, 17 of the Co-based alloy containing Cr. Further, incorporation of B in the magnetic layers 15, 17 reduces the crystal grain size of the magnetic layer, thereby decreasing the medium noise.

Since the intermediate region 16 with high oxygen concentration is provided between the second magnetic layer 15 and the third magnetic layer 17, the crystal grains of the third magnetic layer 17 are miniaturized to improve the S/N, which improves the bit error rate.

The combination of the magnetic recording medium described above with a magnetoresistive head (MR head, GMR head, TMR head, etc.) makes it possible to obtain an in-plane recording density of 95 Mbit or more per 1 mm².

The magnetic recording medium of the constitution described above is formed on the substrate 10 by sputtering a target. Effective examples of physical vapor deposition methods include methods such as DC sputtering, RF sputtering, and DC pulse sputtering. In a case of using the DC sputtering method, it is preferred to apply a bias voltage in the process of the second magnetic layer 15 and beyond in view of an increase in coercivity.

A method of manufacturing the magnetic recording medium described above will be specifically described below in accordance with the constitution shown in FIG. 1. After alkali cleaning and drying of the aluminosilicate glass substrate 10, a Ti-40at. % Co-10at. % Ni alloy layer 15 nm thick as the first underlayer 11 and a W-30at. % Co alloy layer 3 nm thick are formed at room temperature. After heating of the substrate to a temperature of about 400° C. by means of a lamp heater, a Cr-10at %. Ti-3at. % B alloy 8 nm thick is formed as the third underlayer 13. Further, the first magnetic layer 14 (M1), comprising a Co-16at. % Cr-9at. % Pt alloy, 0.4 to 2.5 nm thick, and the second magnetic layer 15 (M2) 10 nm thick comprising a Co-23at. % Cr-13at. % Pt-5at. % B-2at. % Ta alloy were formed. Then, the intermediate layer (Th) 16 with high oxygen concentration is formed while being kept in an evacuated state for 6.5 sec. Thereafter, the third magnetic layer 17 (M3), 7 to 8 nm thick comprising a Co-12at. % Cr-13at. % Cr-12at. % B alloy, is formed, and the film 18, 3 nm thick comprising carbon as the main ingredient, is formed as the protective film. After formation of the carbon film, a lubricant comprising a perfluoroalkyl polyether as the main ingredient is coated to form a lubrication film 1.8 nm thick.

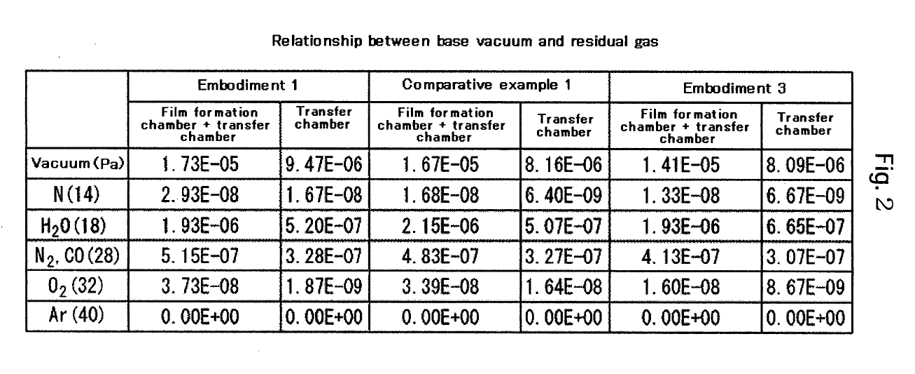

A single wafer type sputtering apparatus was used for the formation of the multi-layered film. FIG. 2 shows the base pressure and the results of residual gas analysis in the sputtering apparatus. When the film forming chamber (sputter gun) and a main vacuum chamber (main chamber) were exhausted simultaneously, the base pressure was 1.4 to 1.8×10⁻⁵ Pa. When the base pressure was measured solely for the main vacuum chamber as the substrate transfer chamber while shutting the film forming chamber, it was 0.8 to 1.0×10⁻⁵ Pa. The results for the residual gas analysis of the vacuum system are described together in the lower stage of FIG. 2 for the base pressure. As a result of examining the partial pressure of residual gases with Mass Nos. of 14, 18, 28, 32, and 40, the back pressure with the Mass No. 18 which is considered to contain water as the main ingredient was highest in a case where the film forming chamber was exhausted simultaneously with the main vacuum chamber. The back pressure with Mass No. 28 which is considered to contain nitrogen or carbon monoxide as the main ingredient was next to the highest. The back pressure with Mass No. 32 comprising oxygen as the main ingredient was lower by more than one digit as compared with Mass No. 28. In view of the relationship, it is probable that the ratio attributable to nitrogen is small among the residual gas ingredients detected for Mass No. 28. The result also agrees with the low partial pressure of nitrogen with Mass No. 14.

On the basis of the comparison of the residual gas analysis between the case of exhausting the film forming chamber and transfer chamber simultaneously and a case where only the transfer chamber is exhausted, the film forming chamber is lower in vacuum and higher in water back pressure than the transfer chamber. The tact for substrate transfer was set to 8.5 sec. The first underlayer 11 to the third magnetic layer 17 were formed in an Ar gas atmosphere at 0.93 Pa.

Heating was conducted in a mixed gas atmosphere with addition of one mol of oxygen to Ar, and the carbon protective film was formed in a mixed gas atmosphere with addition of 10 mol % nitrogen to Ar. A bias voltage at 200 V was applied to the substrate 10 during sputtering of the second magnetic layer 15 and the third magnetic layer 17. The electric discharging time for the first underlayer 11, the magnetic layer 15 and the third magnetic layer 17 was 4.5 sec, the electric discharging time for the second underlayer 12 and the first magnetic layer 14 was set to 2.5 sec, and the electric discharging time for the third underlayer 13 was set to 4.0 sec. The third magnetic layer (M3) 17 was formed after the film forming chamber independent of the transfer chamber had been kept in an exhausted state for 6.5 sec between formation of the second magnetic layer (M1) 15 and that of the third magnetic layer (M3) 17.

As for comparative example 1, the second magnetic layer (M2) and the third magnetic layer (M3) were formed continuously at an 8.5 sec interval without keeping the film forming chamber independent of the transfer chamber in an exhausted state for 6.5 sec between the formation of the second magnetic layer and that of the third magnetic layer.

Brt (Br: residual magnetization of a magnetic layer, t: thickness of the magnetic layer), residual coercivity Hcr, and coercivity squareness ratio S*r of the media were evaluated by using a Fast Remanent Moment Magnetometer (FRMM). KV/kT (K: crystal magnetic anisotropy constant, V: volume of maganetic crystal grains, k: Boltzman constant, T: absolute temperature) was determined by using a vibrating sample magnetometer (VSM), fitting the time dependence of the residual coercivity from 7.5 to 240 sec at room temperature to the Sharrock's equation. The inventors' studies led to the result that the output decay due to thermal fluctuation can be suppressed to provide no problem in view of the reliability in a case where KV/kT determined by the method was about 70 or more. BrOR was determined by measuring Brt in the circumferential direction and radial direction of a medium at room temperature and dividing the Brt in the circumferential direction by the Brt in the radial direction.

The electromagnetic conversion characteristic was evaluated in combination with a composite head having a recording electromagnetic induction magnetic head and a reading spin valve type magnetic head together on a spin stand. The head writing current was set to 37 mA and sense current was set to 2.8 mA. The maximum linear recording density Hf was set to 35.6 kFC/mm, the skew angle was set to 0° and the number of rotation of the medium was set to 70 s⁻¹ (4200 rpm). The writing track width was 0.25 μm and the reading track width is 0.23 μm for the isolated reading waves. Recording was conducted at the highest recording density Hf of 35.6 kFC/mm to evaluate normalized noise (kNdHf). Further, recording was conducted at a medium recording density Mf=Hf/2 to evaluate the normalized noise (kNdMf). Further, DC demagnetization was conducted to evaluate normalized noise (kNdDC).

The signal-to-noise ratio (Siso/Nd) was determined based on the output upon recording as the isolated read waves with 0.79 kFC/mm (20 kFCI) and the medium noise Nd at the high recording density Hf. After recording at the low recording density Lf=Hf/10, high recording density Hf signals were overwritten to determine the overwrite characteristic O/W based on the Lf signal decay ratio. The bit error rate (BER) was determined by counting the number of error bits relative to the total number of read bits upon reading just after recording at a random pattern for about one turn of a specified track. Further, PW50 is an output half-value width of isolated read waves upon recording at 0.79 kFC/mm (20 kFCI).

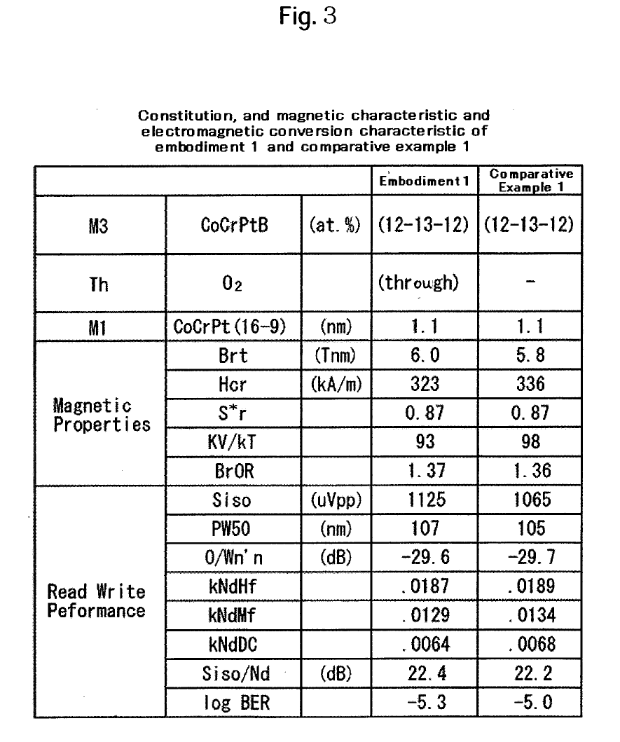

FIG. 3 shows Brt, Hcr, S*r, KV/kT, BrOR, Siso, PW50, O/W, kNdhf, kNdMf, kNdDC, Siso/Nd, logarithmic expression log BER for BER for embodiment 1 and comparative example 1. As shown in embodiment 1 in FIG. 1, after the second magnetic layer (M2) 15 with a thickness of 10 nm is formed which comprises the Co-23at. % Cr-13at. % Pt-5at. % B-2at. % Ta alloy, it is left in vacuum with high water partial pressure for 6.5 sec without forming M3 and then the third magnetic layer 17 comprising the Co-12at. % Cr-13at. % Pt-12at. % B alloy is formed as M3. In this case, it is probable that surface modification (Th) for M2 is caused by adsorption of water or oxygen formed by decomposition of plasma at the M2/M3 boundary. By adjusting the M2/M3 boundary by exposure to an atmosphere with high water back pressure, log BER can be improved compared with comparative example 1.

KV/kT lowers to 93 in embodiment 1 and to 98 in comparative example 1. However, KV/kT as the index for the thermal demagnetization is sufficiently larger than 70. Actually, as a result of measuring the thermal demagnetization at 65° C. by using a spin stand, the average value of the output reduction rates at 7.9 kFC/mm, 11.8 KFC/mm, and 15.8 kFC/mm was stable at 0.48% per unit time digit.

### Embodiment 2

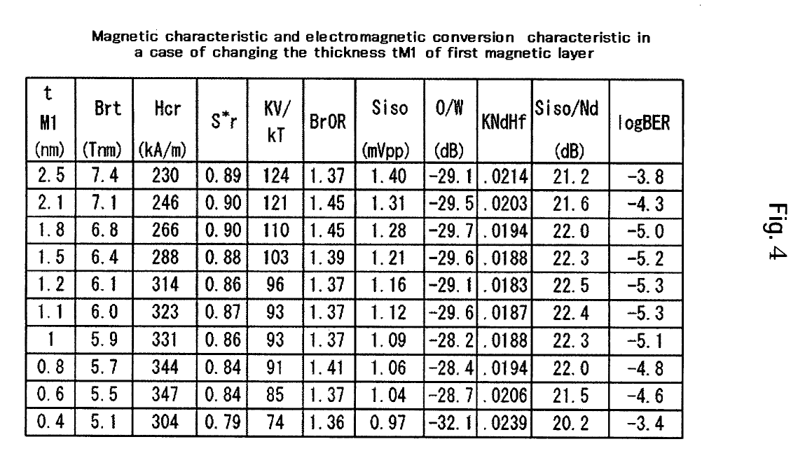

In embodiment 2, a magnetic recording medium was formed in the same manner as in Example 1 except for changing the thickness of the first magnetic layer (M1) 14 and its magnetic characteristic and electromagnetic conversion characteristic were evaluated. FIG. 4 shows the results. Brt of the medium increased along with increase of the film thickness tM1 of the first magnetic layer 14. Hcr was the maximum near 0.6 mm of the thickness of the first magnetic layer 14 and it was greatly decreased to 280 kA/m or less along with increase of the film thickness as the thickness of the first magnetic layer 14 exceeded 1.5 nm. At the thickness of the first magnetic layer 14 of about 1.0 to 1.5 nm, kNdHf was decreased most and BER was decreased to −5.1 or less. Also in a case where the thickness of the first magnetic layer was 1.8 nm, satisfactory BER that was near the case of the film thickness of about 1.0 to 1.5 nm was obtained.

As the thickness of the first magnetic layer was 0.6 nm or less, or 2.1 nm or more, kNdHf, Siso/Nd, and BER were greatly degraded. However, KV/kT increases as the thickness of the first magnetic layer 14 increases. The electromagnetic conversion characteristic is degraded in a case where the thickness (tM1) of the first magnetic layer 14 is 0.6 nm. This is because the crystallographic orientation of the second magnetic layer 15 and the succeeding layers grown thereover is deteriorated. That is, in a case where the thickness of the first magnetic layer 14 is 0.6 nm or less, the Co—Cr—Pt alloy film cannot completely cover the surface of the Cr—Ti—B alloy underlayer and this results in a portion where the second magnetic layer 15 is in contact with the underlayer 13. Consequently, the Co alloy in the hcp structure causes less in-plane orientation. Since Hcr was decreased greatly at the film thickness of the first magnetic layer 14 of 2.1 nm or more, electromagnetic conversion characteristic was greatly degraded.

### Embodiment 3

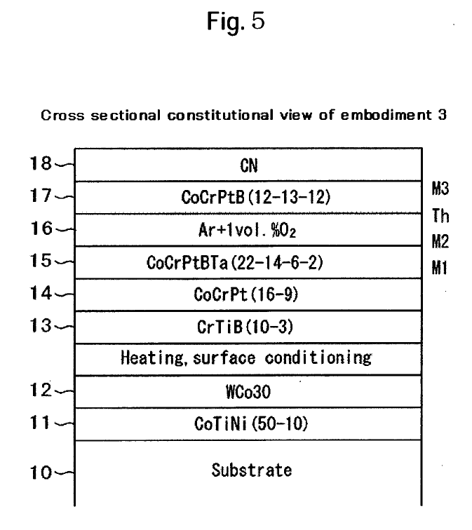

Recording media are formed in the same manner as in embodiment 1 by forming the second magnetic layer (M2) 15 with a thickness of 11.4 nm comprising a Co-22at. % Cr-14at. % Pt-6at. % B-2at. % Ta alloy, instead of the second magnetic layer (M2) 15 used in embodiment 1, and then exposing them to a gas with addition of 1 mol % oxygen 02 to argon Ar for 2.5 sec. FIG. 5 shows a cross sectional structure of embodiment 3. The pressure of the gas introduced to the film forming chamber is changed from 0 Pa (no addition) to 1.87 Pa upon exposure of M3 in FIG. 5 to argon containing 1 mol % of oxygen.

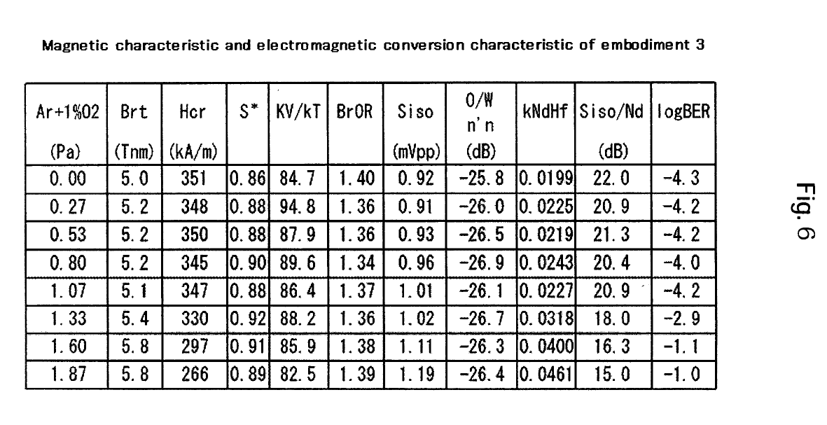

The electromagnetic conversion characteristic was evaluated in combination with a composite type head having a recording electromagnetic induction magnetic head and a reading spin valve type magnetic head together on a spin stand. In this embodiment, evaluation was conducted by using a head different from the head used in embodiment 1. The head writing current was set to 37 mA and sense current was set to 2.6 mA. The maximum linear recording density Hf was set to 35.6 kFC/mm, the skew angle was set to 0°, and the number of rotation of the medium was set to 70 s⁻¹ (4200 rpm). The writing track width was 0.25 μm and the reading track width was 0.23 μm for isolated read waves. Further, recording was conducted with the maximum recording density Hf at 35.6 kFC/mm to evaluate normalized noise (kNdHf). FIG. 6 shows Brt, Hcr, S*r, KV/kT, BrOR, Siso, PW50, O/W, kNdhf, Siso/Nd, and logarithmic expression log BER for BER in embodiment 3.

As the gas pressure for exposing the surface of the M2 increased, Brt increased at 1.33 Pa or more. The increasing trend of the isolated read wave output Siso was more remarkable than the change. That is, Siso increased monotonously along with increase of the exposure gas pressure. When the pressure for Ar+1 mol % O2 was increased from 0 Pa to 1.07 Pa, lowering of Brt and Hcr was scarcely observed, and log BER was not deteriorated. However, log BER was degraded abruptly when the exposure gas pressure increased up to 1.33 Pa.

From the results described above, even when exposure to an Ar gas containing oxygen up to 1.07 Pa×1.5 sec=2.7 Pa·sec after forming the second magnetic layer 15, log BER is substantially equal to that in a case without exposure and Siso and KV/kT can be increased. On the other hand, in a case of exposure to oxygen in excess of 2.7 Pa sec as 1.33 Pa×2.5 sec=3.3 Pa·sec 1 mol %, since log BER is deteriorated abruptly, it was found that exposure to oxygen at M2/M3 boundary has an upper limit. Considering the partial pressure of oxygen, exposure to oxygen of 27 mPa·sec produces an effect of increasing the read output and KV/kT and providing favorable bit error rate. On the other hand, exposure to oxygen in excess of 27 mPa·sec as 33 mPa·sec, log BER is deteriorated abruptly.

### COMPARATIVE EXAMPLE 2

As comparative example 2, magnetic recording media not formed with the first magnetic layer 14 were manufactured. Output signals could not be obtained from any of the media not formed with the first magnetic layer 14 in the evaluation using FRMM, and magnetic characteristic could not be evaluated. It is probable that this is attributable to that preferential orientation was not conducted in the plane in the second magnetic layer 15 and the third magnetic layer 17 in a case where the first magnetic layer 14 was not formed. From the foregoing, it can be seen that formation of the first magnetic layer 14 is essential for conducting preferential orientation in the plane on the second magnetic layer 15 and the third magnetic layer 17.

### COMPARATIVE EXAMPLE 3

As comparative example 3, magnetic recording media not formed with the third magnetic layer 17 were also manufactured. In any of the media not formed with the third magnetic layer 17, Hcr decreased by 100 kA/m or more to result in a remarkable problem with the thermal stability. It is probable that since the second magnetic layer 15 has high Cr concentration and small crystal magnetic anisotropy, sufficient coercivity could be kept no more in a case where the third magnetic layer 17 having lower Cr concentration than that of the second magnetic layer 15 and larger crystal magnetic anisotropy was not formed.

While formation of the second magnetic layer 15 with high Cr is effective in decreasing Brt and decreasing noise, the magnetic layer with high Cr concentration has small coercivity and cannot ensure thermal stability. Accordingly, in a case of forming the second magnetic layer 15 with high Cr concentration, it is essential to form the third magnetic layer 17 with lower Cr concentration than that of the second magnetic layer 15 thereover for ensuring the thermal stability. In a case of forming the third magnetic layer 17 with higher Cr concentration than that of the second magnetic layer 15, the coercivity can no more be obtained and thermal stability cannot be ensured. Therefore, it is necessary to form the third magnetic layer 17 with lower Cr concentration than that of the second magnetic layer 15. Generally, the output characteristic can be improved by increasing the ratio of a ferromagnetic material such as cobalt to a non-magnetic material such as chromium in upper layers. Incidentally, platinum shows the ferromagnetic property by being mixed with cobalt. Accordingly, it is possible to improve the output characteristic along with decreased noise by increasing the concentrations of cobalt and platinum in the layers above the second magnetic layer and arranging the orientation in the first magnetic layer 14.

### Embodiment 4

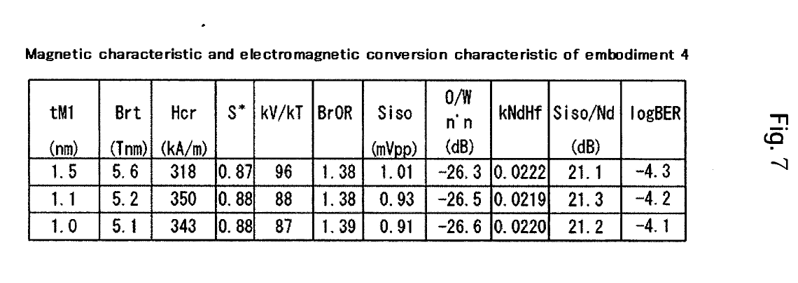

Magnetic recording media were formed and the magnetic characteristic and the electromagnetic conversion characteristic were evaluated in the same manner as in embodiment 3 except for setting the pressure to 0.53 Pa and the time to 2.5 sec for oxygen exposure in embodiment 3 and changing the thickness of the first magnetic layer 14 to 1.0 nm and 1.5 nm in embodiment 3. FIG. 7 shows the results. The results show that almost the same bit error rate as that in embodiment 3 can be obtained also in a case of changing the thickness of the first magnetic layer to about 1.0 nm and 1.5 nm.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A magnetic recording medium comprising:
a substrate;
an underlayer film stacked on the substrate;
a first magnetic layer of a Co-based alloy containing Cr stacked on the underlayer film;
a second magnetic layer which is a Co-based alloy layer containing Cr, Pt, and B and stacked on the first magnetic layer and has higher Cr concentration and larger film thickness than Cr concentration and film thickness of the first magnetic layer;
a third magnetic layer which is a Co-based alloy layer containing Cr, Pt, and B and stacked on the second magnetic layer and has lower Cr concentration than Cr concentration of the second magnetic layer;
an intermediate region formed between the second magnetic layer and the third magnetic layer and having a higher oxygen concentration than oxygen concentration of the magnetic layer; and
a protective film stacked on the third magnetic layer.

2. A magnetic recording medium according to claim 1, wherein the first magnetic layer has a film thickness of about 1 nm or more and about 1.5 nm or less.

3. A magnetic recording medium according to claim 1, wherein the underlayer film comprises a plurality of underlayers and an underlayer in contact with the first magnetic layer contains B.

4. A magnetic recording medium according to claim 1, wherein the underlayer film has a first underlayer for ensuring sliding reliability, a second underlayer for ensuring mechanical reliability, and a third underlayer for miniaturizing crystal grains in the first magnetic layer film.

5. A magnetic recording medium according to claim 1, wherein the underlayer film has a first underlayer comprising any one of a TiCo alloy, a TiCoNi alloy, and a NiTa alloy, a second underlayer comprising a WCo alloy or Ta, and a third underlayer comprising a CrTiB alloy or a CrTi alloy.

6. A magnetic recording medium according to claim 5, wherein the first magnetic layer is a CoCrPt alloy layer, the second magnetic layer is a CoCrPtBTa alloy layer, and the third magnetic layer is a CoCrPtB alloy layer.

7. A magnetic recording medium according to claim 1, wherein a film thickness of the first magnetic layer is smaller than a film thickness of the second magnetic layer.

8. A magnetic recording medium according to claim 1, wherein the first magnetic layer has a film thickness of about 1 nm or more and about 2.1 nm or less.

9. A magnetic recording medium comprising:
a substrate;
an underlayer film stacked on the substrate;
a first magnetic layer of a Co-based alloy containing Cr stacked on the underlayer film;
a second magnetic layer which is a Co-based alloy layer containing Cr, Pt, and B and stacked on the first magnetic layer and has higher Cr concentration and thicker film thickness than Cr concentration and film thickness of the first magnetic layer;
a third magnetic layer which is a Co-based alloy layer containing Cr, Pt, and B and stacked on the second magnetic layer and has lower Cr concentration than Cr concentration of the second magnetic layer;
an intermediate region formed between the second magnetic layer and the third magnetic layer and having an ArO₂ concentration higher than ArO₂ concentration of the magnetic layer; and
a protective film stacked on the third magnetic layer.

10. A magnetic recording medium according to claim 9, wherein the first magnetic layer has a thickness of about 1 nm or more and about 1.5 nm or less.

11. A magnetic recording medium according to claim 9, wherein the underlayer film comprises a plurality of underlayers and an underlayer in contact with the first magnetic layer contains B.

12. A magnetic recording medium according to claim 9, wherein the underlayer film has a first underlayer for ensuring sliding reliability, a second underlayer for ensuring mechanical reliability, and a third underlayer for miniaturizing crystal grains in the first magnetic layer film.

13. A magnetic recording medium according to claim 9, wherein the underlayer film has a first underlayer comprising any one of a TiCo alloy, a TiCoNi alloy, and a NiTa alloy, a second underlayer comprising a WCo alloy or Ta, and a third underlayer comprising a CrTiB alloy or a CrTi alloy.

14. A magnetic recording medium according to claim 13, wherein the first magnetic layer is a CoCrPt alloy layer, the second magnetic layer is a CoCrPtBTa alloy layer, and the third magnetic layer is a CoCrPtB alloy layer.

15. A magnetic recording medium according to claim 9, wherein a film thickness of the first magnetic layer is smaller than a film thickness of the second magnetic layer.
